(19) United States
(12) Patent Application Publication
(10) Pub. No.: US 2018/0128032 A1
(43) Pub. Date: May 10, 2018

(54) Piece of Furniture, in Particular a Cabinet Unit

(71) Applicant: Kunststoff Kommanditgesellschaft Nehl & Co., Bünde-Hunnbrock (DE)

(72) Inventors: Torben Karle, Melle (DE); Gerd Noltemeier, Bad Essen (DE); Benjamin Milto, Gütersloh (DE)

(21) Appl. No.: 15/536,661

(22) PCT Filed: Dec. 15, 2015
(86) PCT No.: PCT/EP2015/002516

§ 371 Date: Dec. 23, 2017

(30) Foreign Application Priority Data
Dec. 18, 2014 (DE) 10 2014 018 682.2

(51) Int. Cl. E05F 15/605; E05D 15/26; E05D 15/58; E05F 15/686; E05F 15/638

(52) U.S. Cl. CPC E05F 15/605; E05D 15/264; E05D 15/262; E05Y 2900/212; E05F 15/686; E05F 15/638; E05D 15/583

(57) ABSTRACT

Piece of furniture, in particular a cabinet unit, having a furniture body which comprises side walls, a base and a cover wall and which can be closed and opened by means of a folding door arrangement 1 which has at least two folding door elements 2, 3 which can be pivoted towards one another about a horizontal pivot axis during an opening operation of the folding door arrangement 1 and can be pivoted away from one another about the horizontal pivot axis during a closing operation of the folding door arrangement 1, wherein one 3 of the at least two folding door elements 2, 3 is movably guided in the course of its opening pivoting movement along vertically oriented sliding guides 10 and the at least two folding door elements 2, 3 can be transferred into a substantially horizontally oriented raised opening intermediate position, from which they are movable through a horizontally oriented movement translationally along horizontal guides 14 into their opening end position within the furniture body, wherein at least one of the at least two folding door elements 2, 3 is movable into its raised opening intermediate position by a first motor drive 11 and from the opening intermediate position into its opening end position by a second motor drive 12.

The invention concerns a piece of furniture, in particular a cabinet unit, with a furniture body comprising sidewalls, a bottom as well as a top wall, that is closable and openable by means of a folding door arrangement comprising at least two folding door elements that, in an opening process of the folding door arrangement, are pivotable toward each other about a horizontal pivot axis and, in a closing process of the folding door arrangement, are pivotable about the horizontal pivot axis away from each other, wherein the at least two folding door elements during the course of their opening pivot movement are movably guided along vertically oriented sliding guides and transferable into a raised, substantially horizontally oriented, intermediate open position from where they are movable translatorily by a horizontally oriented movement along horizontal guides into their open end position inside the furniture body.

Pieces of furniture, in particular cabinet units such as upper hanging cabinets for kitchens have in general doors that are pivotable about vertically oriented axes which, after the transfer into their open position, project into the kitchen space and thereby present an obstacle for operating persons.

Moreover, it is known to pivot doors of such cabinets upwardly about a horizontal axis by a pivot movement, wherein, in their open position, they also project into the kitchen space but in a raised position so that they present no obstacle for short persons but they still present an obstacle for tall persons.

In addition, cabinets with folding doors are known that comprise folding door elements pivotable about horizontally oriented axes which can be pivoted toward each other for an opening movement and away from each other for a closing movement. DE 1925314 A discloses such a cabinet unit with two folding door elements, pivotably connected to each other, whose lower folding door element has guide members which engage in vertically oriented sliding guides, provided at the front inner sides of the sidewalls of the furniture body, and slide upwardly in vertical direction into an intermediate open position during the pivot movement of the folding door elements toward each other. In doing so, the lower folding door element pivots towards the upper one so that they are substantially horizontally oriented in the intermediate open position. From this intermediate open position, the folding door elements pivoted toward each other can be displaced as a package into the cabinet interior so that they are positioned therein in their open position in an upper stowage compartment of the furniture body. The vertical guides pass in the upper area into horizontal guides wherein, in the assumed open end position of the folding door elements, the latter remain visible from the viewing side of the piece of furniture. The force expenditure that is required for opening the folding door elements makes this construction of the cabinet difficult to handle, in particular because in the intermediate open position the folding door elements, due to their size, require an increased force expenditure in order to maintain them in a horizontal position in order to be able to subsequently move them horizontally.

It is the object of the present invention to further develop a piece of furniture, in particular a cabinet unit of the aforementioned kind, such that the folding door elements can be transferred with reduced force and operating expenditure from the closed position into the open end position.

As a solution to this object, the piece of furniture of the aforementioned kind is characterized in that the at least two folding door elements are movable by a first motor drive into their raised intermediate open position and from the intermediate open position are movable into the open end position by a second motor drive.

In this way, a piece of furniture is made available in which by means of the first motor drive the at least two folding door elements can be transferred from their closed position into the raised intermediate open position. This can be realized without additional manual force expenditure because the first motor drive must only take care of pivoting the at least two folding elements toward each other and of transferring the at least two folding elements from their closed position into their vertically raised and substantially horizontally oriented intermediate open position. Two drive motors as first motor drive can be provided which are synchronized with each other. It is however also possible to accomplish this with only one drive motor and to transfer its drive force to both sides of the lower folding door element, for example, of the at least two folding door elements, for example, by pulling means such as, for example, cable pulls with associated cable drum. When the two folding door elements have reached their intermediate open position, the second motor drive takes over the further drive action and the movement process of the at least two folding door elements from the intermediate open position into the open end position in which the at least two folding door elements are to be placed safely into the interior of the furniture body. In this context, the parts can also be configured and arranged such that the first motor drive together with the folding door elements is transferred by the second motor drive also into an end position in which it is positioned behind the two folding door elements in the interior of the furniture body.

It is particularly preferred when not only two folding door elements are provided but three so that the folding door elements with respect to their height dimension in the respective closed position can be designed smaller so that even taller cabinet units with a limited cabinet depth can also be furnished with electrically driven folding door elements. In this context, preferably the basic configuration of the at least two folding door elements is identical.

They can also comprise four-bar linkage arrangements by means of which they can be pivoted wherein a simple joint can be provided between the two folding door elements. The four-bar linkage arrangement associated with the lower folding door element of the at least two folding door elements or the two four-bar linkage arrangements on both sides of the lower folding door element are in this context preferably arranged on a guide body that can glide in corresponding vertical guides and on which the pulling means engages. It can comprise a further carrier on which respectively a connecting element of the third folding door element engages that during the opening movement is entrained by the motor and by the lower folding door element into the intermediate open position in which the third folding door element has not yet been pivoted. Only upon moving the at least two folding door elements that have been pivoted toward each other farther into the furniture body, the third folding door element is moved automatically toward the second folding door element by the second motor drive. For this purpose, guides or another suitable control element can be provided in order to assist this pivot movement of the third folding door element to the second folding door element. Thus, during the horizontal translatory movement of the at least two folding door elements, the third folding door element is successively pivoted onto the second folding door element so that, in the end position of the three folding door elements, they are positioned as a package inside the furniture body.

Another configuration provides that the first motor drive is movable by means of the second motor drive by means of the horizontal guides into a rearward end position in the furniture body and into a forward operating position in the furniture body. In this context, it is also provided that the first motor drive ensures that the folding door elements are transferred into the intermediate open position and the second motor drive then transfers the first motor drive and a package of folding door elements into the rearward end position whereupon the folding door elements together with the motor drives are positioned inside the furniture body interior.

This can be realized in this further embodiment variant in a particularly noise-reduced and slip-free configuration in that by means of a pulling element, in particular a pulling cable, the first motor drive and the second motor drive are coupled in a special way such that the second motor drive by means of a pulling means (e.g. pulling cable), embodied quasi continuous, pulls the first motor drive together with the package of the folding door elements by means of the horizontal guides into the rearward end position. For this purpose, preferably a guide pulley, preferably however two guide pulleys, are provided on the second motor drive. The pulling element is held on this guide pulley that is motion-fixedly coupled with the second motor drive and also on the optional second guide pulley on which then a different end of the pulling means (pulling cable) is fastened. The pulling means can be guided from the guide pulley of the second motor drive across a deflection first along the next horizontal guide, associated with the second motor drive, to a forward fastening support that is relatively movable parallel to the first motor drive within the furniture body from the front to the rear and from the rear to the front. For this purpose, the fastening support can be coupled by means of a cross member with the first motor drive. By means of a deflection at this fastening support the pulling element can then extend diagonally through the furniture body (beginning at a position of the fastening support in the front area of the furniture body) and be guided to a rearward deflection where it is again deflected in an orientation parallel to the horizontal guide along which the first motor drive can be guided. Then the pulling element is guided about the first motor drive in order to be able to entrain it. In this context, special guide and/or fastening elements can be provided on the first motor drive. By means of a deflection on the first motor drive, the pulling element with its other end can extend in turn diagonally through the furniture body and in this context cross the already diagonally extending area of the pulling element and be returned to the second motor drive in order to be attached thereat on the guide pulley or a second guide pulley.

Depending on the rotational direction of the second motor drive (clockwise; counterclockwise), one end area of the pulling element can then unwind from the guide pulley that is associated with this end area and the other end area of the pulling element can be moved by the other guide pulley of the second motor drive so as to be wound up. This can be exactly the opposite for a change of the rotational direction of the second motor drive so that the previously wound-on end area is unwound and the previously unwound end area is wound on, wherein in each case with one and the same pulling element a pulling, i.e., winding movement depending on the rotational direction of the second drive can be performed whereby a slip-free movement course is enabled. Depending on in which direction the pulling element is pulling, the first motor drive that pulls the folding door elements into the furniture body is moved into the rear end position or is moved from the rear end position into the front position whereupon the folding door elements again are transferred into their vertical closed position, be it due to their own weight or be it by motor assistance by the first motor drive. The first motor drive, in turn, can ensure by pulling elements (pulling cables) that can be wound up a lifting movement of the folding door elements or in case of three folding door elements at least the upward movement of two folding door elements pivoting toward each other. For this purpose, the first motor drive is preferably provided with a first pulling means and also with a second pulling means that are moved parallel and simultaneously wherein one pulling element engages a lateral area of at least one folding door element and the other pulling means engages the oppositely positioned lateral area.

As a whole, in this way a very noise-reduced slip-free operation with electro-motoric drives of a very small size is provided.

Further advantageous embodiments of the invention result from additional dependent claims, the following description, and the drawing. The drawing shows in:

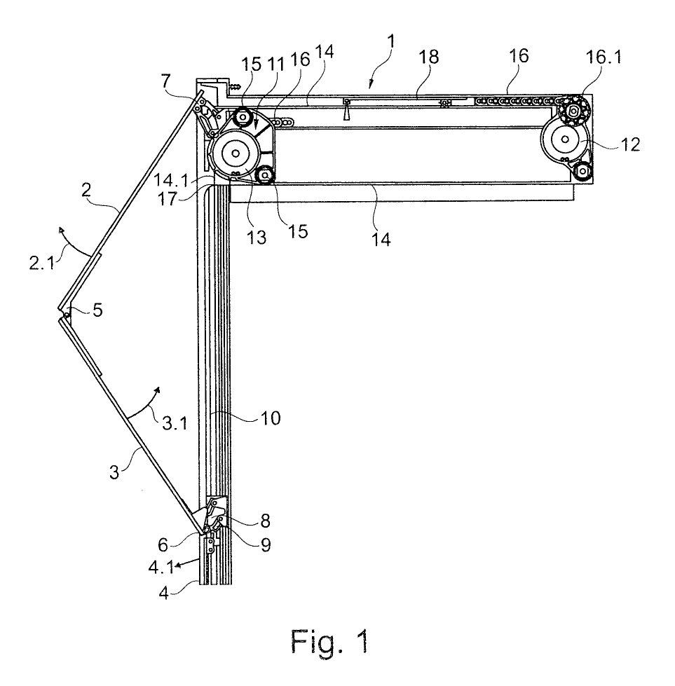

FIG. 1 in a schematic sectioned side view an embodiment of a folding door arrangement for a piece of furniture according to the invention during the course of the opening movement of the folding door arrangement from its closed position into an intermediate open position;

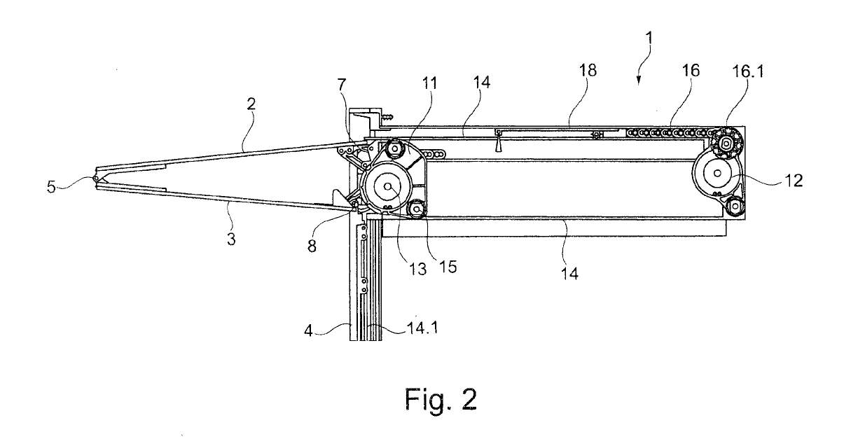

FIG. 2 the embodiment of the folding door arrangement according to FIG. 1 in its intermediate open position;

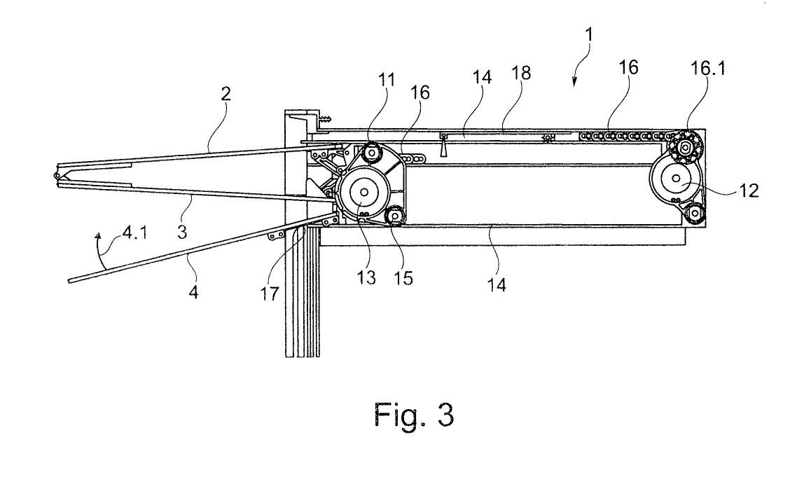

FIG. 3 the embodiment according to FIGS. 1 and 2 of the folding door arrangement at the beginning of the movement from the intermediate open position into the open end position;

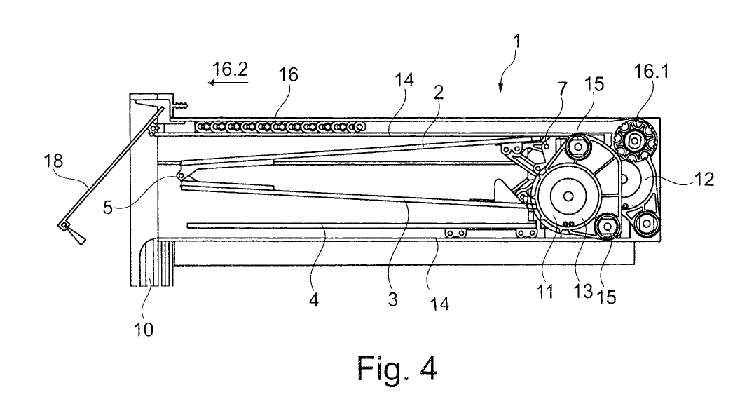

FIG. 4 the embodiment of the folding door arrangement according to FIGS. 1 to 3 with assumed end position of the folding door elements in their open/closed position and that of the closure flap during the course of its closing movement;

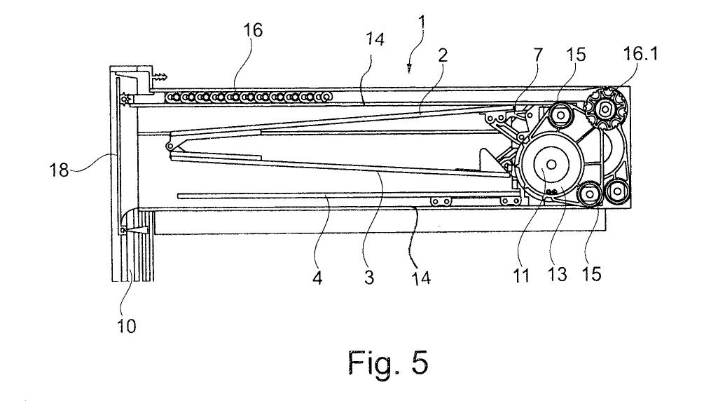

FIG. 5 the embodiment according to FIG. 4 with closed closure flap;

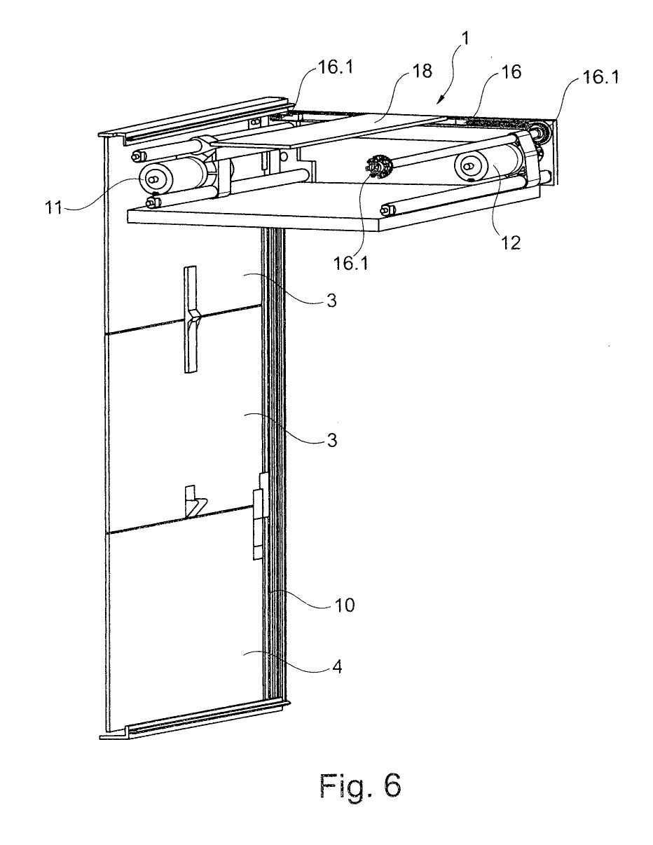

FIG. 6 schematically in perspective partial illustration the folding door arrangement of the embodiments according to FIGS. 1 to 5 in a view from the interior with closed folding door arrangement;

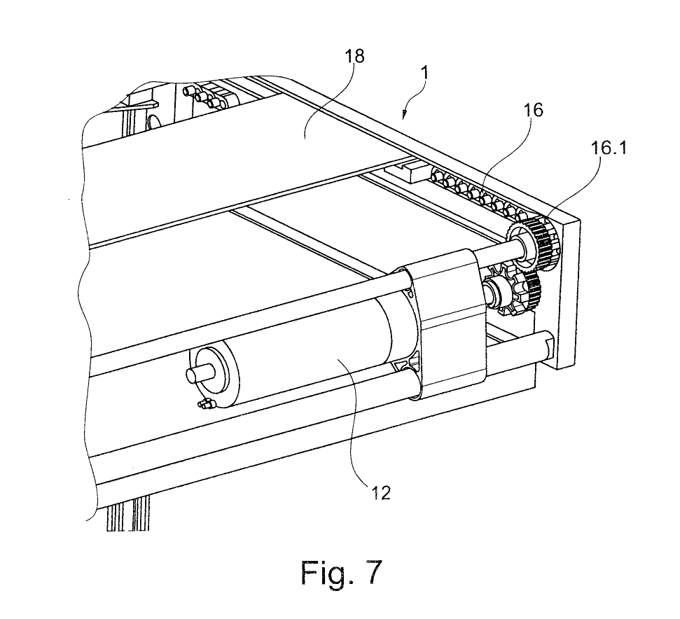

FIG. 7 in enlarged detail a perspective view from the rear onto the second motor drive with a push chain;

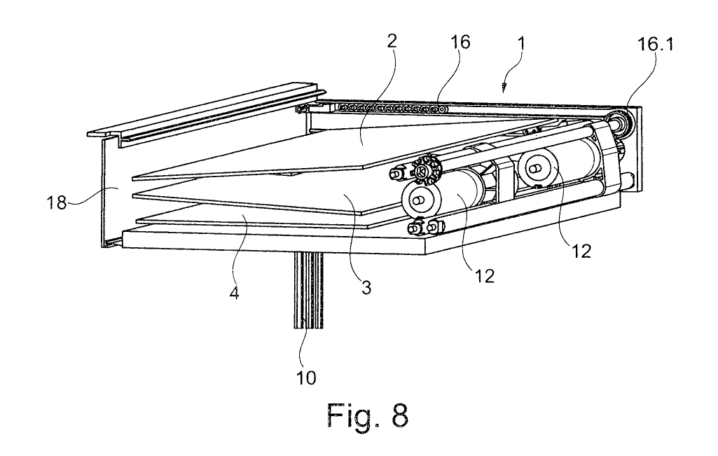

FIG. 8 a perspective detail view laterally from the rear onto the folding door arrangement in its open end position;

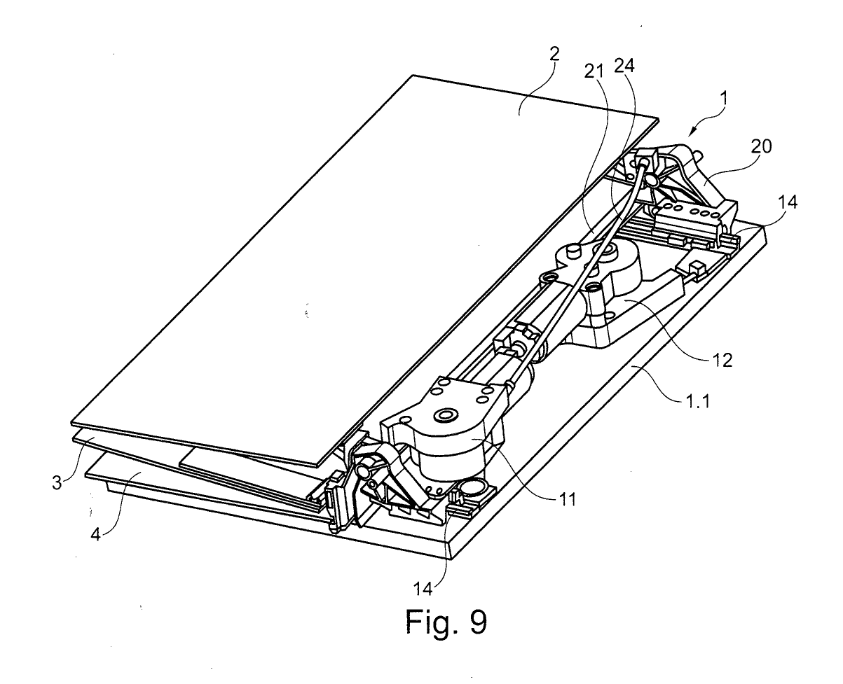

FIG. 9 in a perspective view an alternative embodiment of a folding door arrangement in folded-in state of the folding door arrangement and two motor drives which are located in rearward end positions in the open position of the folding door arrangement;

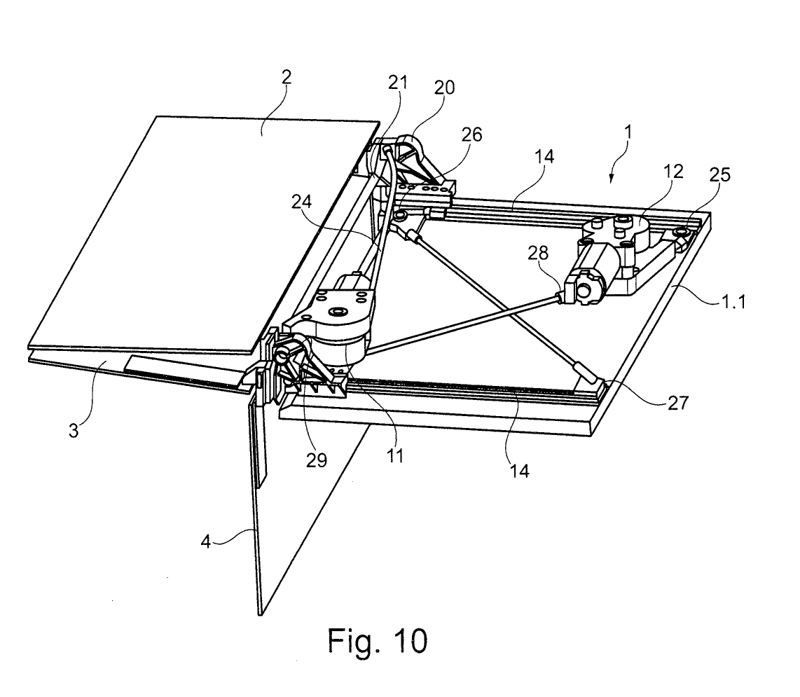

FIG. 10 the embodiment according to FIG. 9 in the raised intermediate open position of the folding door elements;

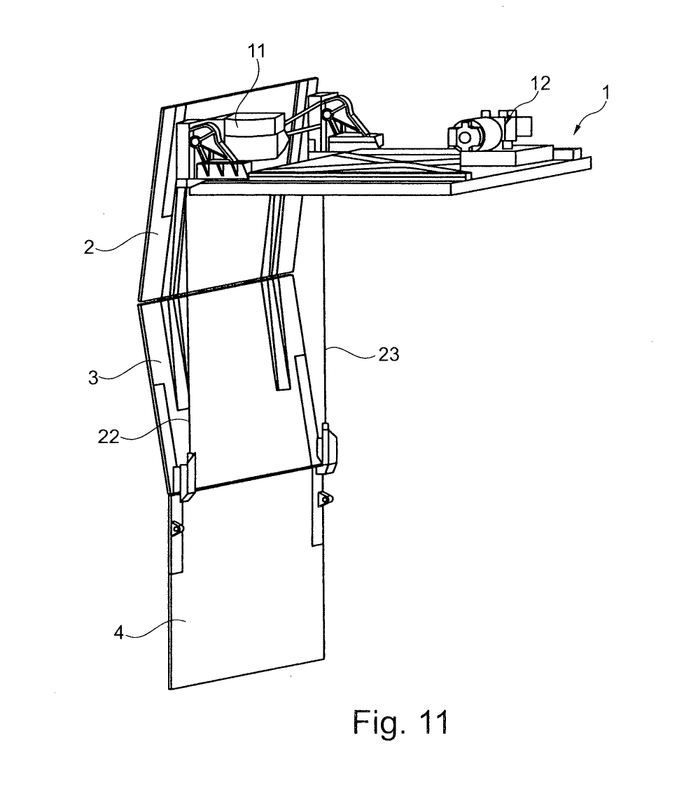

FIG. 11 the embodiment of the folding door arrangement according to FIGS. 9 and 10 at the beginning of an opening process of the folding door elements;

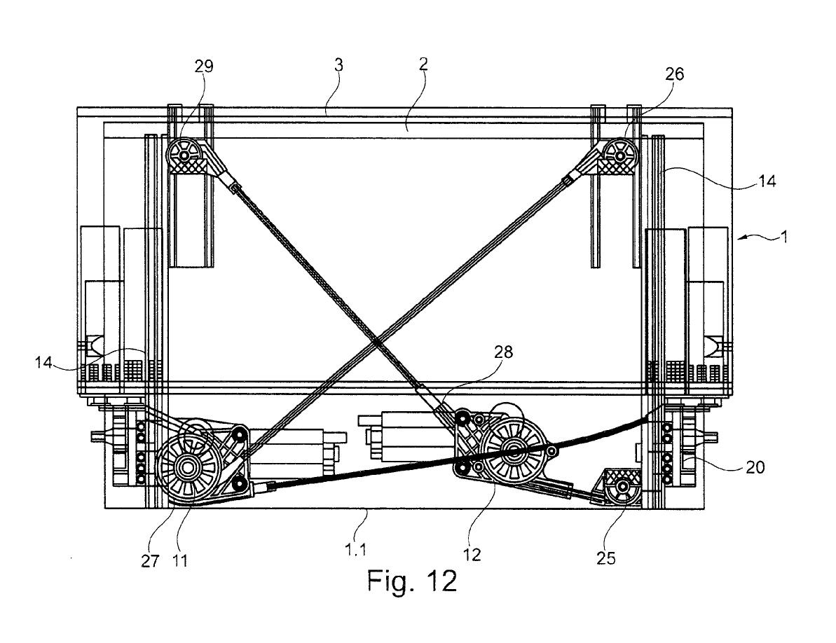

FIG. 12 a plan view of the embodiment according to FIGS. 9 to 11 in the open position of the folding door elements making visible the folding door elements which have been moved into the furniture body below; and

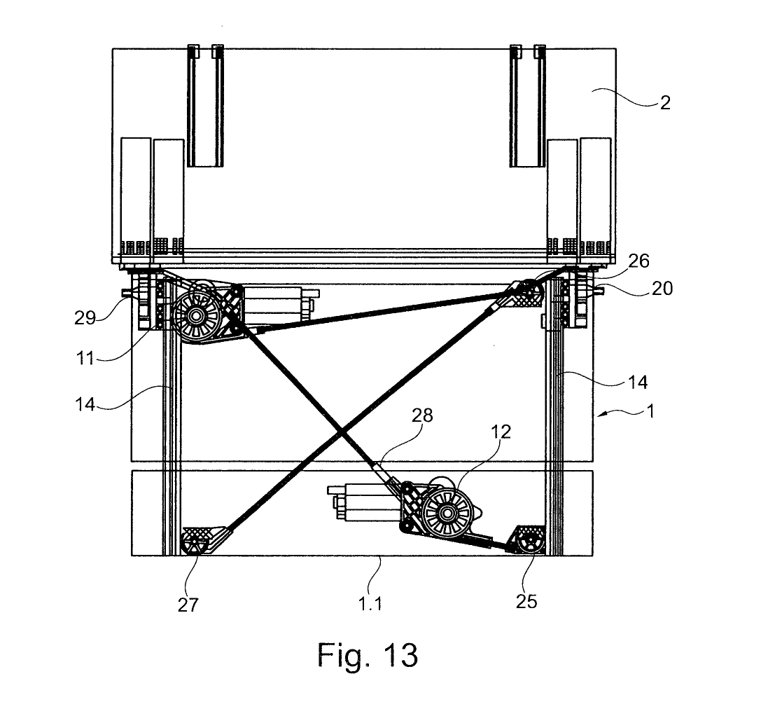

FIG. 13 an illustration in analogy to FIG. 12 in the intermediate open position of the folding door elements.

In FIG. 1, a folding door arrangement, generally identified by 1, for a piece of furniture is shown. The piece of furniture, for better clarity, is not illustrated in detail and is to comprise a furniture body which is provided with sidewalls, a bottom as well as a top wall and a rear wall. This piece of furniture can be a stand-up piece of furniture but also a hanging cabinet unit and can be provided in its interior with storage spaces and/or furnishings. The folding door arrangement is comprised in the illustrated embodiment of an upper folding door element 2, a second or central folding door element 3, and a lower folding door element 4. The folding door elements 2 and 3 are connected by a joint 5 to each other wherein between the folding door element 3 and 4 also a joint 6 is provided. The folding door element can be pivoted in the direction of arrow 2.1, the folding door element 3 in the direction of arrow 3.1, and the folding door element 4 in the direction of arrow 4.1. The folding door elements 2 and 3 each are to be pivoted by a four-bar linkage arrangement 7 and 8 wherein the folding door element 3 has a guide body 9 which can be slidably guided in a vertically oriented sliding guide 10 in upward and downward directions. These guide bodies 9 are provided on both sides, i.e., on two vertical sliding guides 10 on the sidewalls of the furniture body.

A first motor drive is provided which is provided with reference numeral 11 and a second motor drive 12 which is arranged in the rearward area in a furniture body. The first motor drive 11, which may comprise, for example, an electric motor with a drive shaft, comprises at both sides of the furniture body a cable drum 13 onto which a cable 14.1 can be wound that engages the guide body 9 of the folding door element 3. It is also possible to provide only a centrally arranged cable drum. The first motor drive 11 with its cable drums 13 is guided in horizontal guides 14 by pulleys 15 so that the first motor drive 11 with the cable drums 13 is to be moved in the direction of the second motor drive 12 by the latter with entrainment of the folding door elements 2, 3, and 4. Moreover, a push chain 16 can be seen (partially) in FIG. 1 which is guided in deflection pulleys 16.1 and drivable by the second motor drive 12. The second motor drive 12 can comprise one or several electric motors which are synchronized with each other.

In FIG. 2, the folding door elements 2 and 3 have been transferred into a raised position by pulling up the folding door element 3 by means of the pulling cable 14.1 by motor drive 11. In doing so, they have also lifted the third folding door element 4, that has not yet been pivoted up to this moment, into a raised position. This corresponds to an intermediate open position of the folding door elements 2 and 3. From this position on, the second motor drive 12 takes over further movement of the folding door elements 2, 3, and 4 into their open end position in that the push chain 16 the first motor drive together with the cable drum 13 the wound-on cable 14.1 the is pulled in the direction of the second motor drive 12 whereby the third folding door element 4 engages guides 17 and also pivots in the direction 4.1 toward the second folding door element 3, whereupon the folding door elements 2, 3, 4 as a package can be moved, gliding along the horizontal guides 14, into the open end position in that the push chain 16 moves the package of the folding door elements 2, 3, 4 into the space in the upper area of the folding door arrangement and, in the mounted state of this folding door arrangement, into the upper inner area of the furniture body. This is realized by the lower run of the push chain 16, not visible in FIGS. 3 and 4, wherein the push chain 16 in doing so is moved in the direction of the arrow 16.2.

In this context, the push chain 16 also comes into contact with a closure flap 18 which during movement of the upper run of the push chain 16 is moved out of the upper guide 14 to an end stop and there, under the force of gravity, is moved into the position as illustrated in FIG. 5 in which the space, in which the folding door elements 2, 3, and 4 are positioned together with the first drive 11, is closed by the closure flap 18.

In the opposite case, at the beginning of a closing movement of the folding door arrangement 1, the closure flap 18 is moved by the opposite movement of the push chain 16 first into its open position whereupon the folding door elements 2, 3, and 4 together with the drive motor 11 are moved out of the interior of the folding door arrangement 1 in order to close the furniture body. This is realized without additional force expenditure by an operating person. The motors can also be activated in automated sequence or by special operating elements.

In FIGS. 9 through 13, an alternative embodiment of the piece of furniture and of the folding door arrangement with the two motor drives 11 and 12 is shown. FIG. 9 shows the state of the folding door arrangement that results when the folding door arrangement is open, i.e., the folding door elements 2, 3, 4 are folded into a package and they are positioned above the structural bottom 1.1 within the piece of furniture. It is apparent that the second motor drive 12 is located in the rearward area of the structural bottom 1.1, but also the first motor drive 11 which in this position has been moved by the second motor drive along the horizontal guides 14 from a forward operating position into this rearward operating end position. Moreover, a fastening support 20 can be seen that by means of a cross member 21 is motion-coupled with the first motor drive 11. In the first motor drive 11 pulling means (pulling cables) 22 and 23 are to be wound onto and unwound from corresponding guide pulleys so that by means of the motor drive 11, as can be seen in FIG. 11, the folding door elements can be lifted. The pulling means 23 is guided across the cable pull guide 24 from the corresponding guide pulley of the first motor drive 11 to the fastening support 20 and from there (FIG. 11) can be guided to the corresponding fastening location on the folding door element 3 so that the pulling elements 22 and 23 engage oppositely positioned lateral areas of the folding door element 3.

In FIG. 10, the position of the folding door elements 2, 3, and 4 in the intermediate open position is illustrated. In this position, the motor drive 12 has become active and has transferred the first motor drive 11 and the fastening support 20, which by means of the cross member 21 are motion-synchronized, from the rearward end position illustrated in FIG. 9 into the forward position on the structural bottom 1.1 in which the folding elements 2, 3, and 4 are located in the intermediate open position. For this purpose, on the motor drive 12 two guide pulleys are provided wherein on each guide pulley one end of a pulling means is attached. The motor drive 12, like the motor drive 11, can be moved in opposite directions so that the corresponding guide pulleys rotate in clockwise direction and in counterclockwise direction, respectively, in order to be able to exert the corresponding retraction movement or extraction movement of the folding door elements 2, 3, and 4. From the guide pulley (not illustrated in detail) of the second motor drive 12, the pulling element (preferably the pulling cable) is guided across a first deflection 25 and extends then parallel to the horizontal guide to the right in FIG. 10, reaches thereat the fastening support 20 across which it is guided so that motion entrainment can be realized.

Subsequently, by a further deflection 26 it is deflected and extends diagonally across the structural bottom 1.1 to a further deflection 27 which is located thus on the opposite side of the structural bottom 1.1 in the rearward area of the structural bottom 1.1. Here the pulling element is again deflected and extends parallel to the horizontal guide 14 to the left in FIG. 10, then reaches the first motor drive 11 where it is again deflected with motion entrainment possibility of the corresponding first motor drive 11 and reaches then, again extending diagonally across the structural bottom 1.1, at 28 a guide pulley of the second motor drive 12.

When the motor drive 12 moves counterclockwise, the end of the pulling means at 28 is pulled from the guide pulley provided thereat by the second motor drive 12 wherein the first end of the pulling means is unwound from the other pulley.

Accordingly, a continuous winding and unwinding of the respective end of the pulling means with corresponding entrainment of the first motor drives 11, the fastening support 20, and the folding door elements 2, 3, and 4 is provided.

Therefore, depending on the direction of rotation of the second motor drive, a noise-reduced, slip-free movement course of the aforementioned parts is enabled.

FIG. 11 shows the corresponding parts again during the beginning of an opening movement.

In FIGS. 12 and 13, the course of the position of the respective motor drive 11 and 12 and of the fastening support is illustrated in analogy to FIG. 9 and in analogy to FIG. 10, respectively. Here, it can be seen that in FIG. 12 the first motor drive is located in the rearward left end area of the structural bottom 1.1 as is the fastening support 20, while in FIG. 13 the first motor drive 11 is located in the forward area of the construction bottom 1.1 as is the fastening support 20.

What is claimed is:

1.-23. (canceled)

24. A piece of furniture comprising:
a furniture body comprising a bottom, a top wall, and sidewalls connecting the bottom and the top wall;
a folding door arrangement connected to a front of the furniture body for opening and closing the piece of furniture, wherein the folding door arrangement comprises a first folding door element and a second folding door element, wherein the first and second folding door elements are pivotably connected to each other about a horizontal pivot axis and are pivotable toward each other about the horizontal pivot axis by an opening pivot movement of the folding door arrangement and pivotable about the horizontal pivot axis away from each other by a closing movement of the folding door arrangement;
vertically oriented sliding guides disposed at the sidewalls, wherein the first folding door element, during the opening pivot movement, is movably guided along the vertically oriented sliding guides and wherein the first and second folding door elements are transferable into a substantially horizontally oriented raised intermediate open position;
horizontal guides disposed in an upper area of the furniture body, wherein the first and second folding door elements are movable along the horizontal guides from the raised intermediate open position translatorily into an open end position in an interior of the furniture body;
a first motor drive operatively connected to at least one of the first and second folding door elements;
a second motor drive operatively connected to said at least one of the first and second folding door elements;
wherein said at least one of the first and second folding door elements is movable by the first motor drive by a vertical movement into the raised intermediate open position and by the second motor drive by a horizontal translatory movement from the raised intermediate open position into the open end position;
wherein the first and second folding door elements in the open end position are arranged in an upper furniture body space in the interior of the furniture body;
a closure cover closing off in a closed position the upper furniture body space in the open end position of the first and second folding door elements.

25. The piece of furniture according to claim 24, wherein the folding door arrangement comprises a third folding door element that is pivotably connected to the first folding door element, wherein during transfer of the first and second folding door elements from the raised intermediate open position into the open end position, the third folding door element is pivotable toward the first folding door element and is movable by the second motor drive together with the first and second folding door elements into the open end position in the interior of the furniture body.

26. The piece of furniture according to claim 25, further comprising a guide disposed on the furniture body for assisting a pivot movement of the third folding door element.

27. The piece of furniture according to claim 25, wherein the first and second folding door elements are connected by four-bar linkage arrangements each comprising a guide body, wherein the guide bodies are movably guided in the vertically oriented sliding guides.

28. The piece of furniture according to claim 27, wherein the first folding door element is guided translatorily in the vertically oriented sliding guides by the guide bodies and entrains the third folding door element when translatorily moving in the vertically oriented sliding guides,

29. The piece of furniture according to claim 28, wherein the first motor drive comprises endless pulling means and at least one pulling means drum, wherein the at least one pulling means drum, when the first and second folding door elements move from the raised intermediate open position into the open end position, is transferable by the second motor drive into a translatorily displaced end position in the interior of the furniture body.

30. The piece of furniture according to claim 29, wherein the endless pulling means is a pulling cable, wherein the at least one pulling means drum is a cable drum.

31. The piece of furniture according to claim 28, wherein the endless pulling means engages the guide bodies of the first folding door element.

32. The piece of furniture according to claim 24, wherein the first and second folding door elements, when moving from the raised intermediate open position into the open end position, are guided by guide means of the first motor drive in the horizontal guides in the interior of the furniture body.

33. The piece of furniture according to claim 32, wherein the guide means of the first motor drive are supported rollingly by pulleys in the horizontal guides.

34. The piece of furniture according to claim 33, wherein the second motor drive is arranged in the interior of the furniture body and is operatively connected by drive transfer means to the first and second folding door elements.

35. The piece of furniture according to claim 34, wherein the drive transfer means are push chains.

36. The piece of furniture according to claim 34, wherein the drive transfer means engage the guide means of the first motor drive.

37. The piece of furniture according to claim 24, wherein the closure cover is transferable from the closed position closing off the upper furniture body space into an open position in the interior of the furniture body.

38. The piece of furniture according to claim 24, wherein the second motor drive is operatively connected by push chains to the first and second folding door elements, wherein the closure cover is connected to the push chains and, when the first and second folding door elements are moved from the raised intermediate open position into the open end position, is transferred by the push chains into the closed position and, when the first and second folding door elements are moved from the open end position into the raised intermediate open position, is moved from the closed position into the open position in the interior of the furniture body.

39. The piece of furniture according to claim 24, wherein the first motor drive is transferable by the second motor drive along the horizontal guides into a rearward end position within the furniture body and into a forward operating position located in the interior of the furniture body.

40. The piece of furniture according to claim 39, wherein the first motor drive comprises pulling means that are extending to at least one of the first and second folding door elements and are secured thereon.

41. The piece of furniture according to claim 39, further comprising an additional guide supporting a fastening support that is movably guided along said additional guide and that is transferable by the second motor drive from a forward operating position located in the interior of the furniture body into a rearward end position located in the interior of the furniture body.

42. The piece of furniture according to claim 41, wherein the second motor drive comprises a guide pulley, which is configured to be driven motorically clockwise and counterclockwise, and further comprises a deflectable pulling element attached to the guide pulley and guided from the guide pulley about a first deflection element to the fastening support and from the fastening support about a second deflection element to one of the horizontal guides so as have a first diagonal extension through the furniture body and is guided along said one horizontal guide to the first motor drive and from the first motor drive to the second motor drive with a second diagonal extension crossing the first diagonal extension of the deflectable pulling element, so that the deflectable pulling element, depending on a rotational direction of the second motor drive, is fixable with a first end so as to unwind from the first motor drive and with the second end so as to wind onto the second motor drive.

43. The piece of furniture according to claim 42, wherein the deflectable pulling element is fastenable with end areas to deflection pulleys of the second motor drive.

44. The piece of furniture according to claim 42, wherein the first motor drive and the fastening support are motion-coupled by a cross member.

45. The piece of furniture according to claim 42, wherein the deflectable pulling element is a pulling cable.
